(19) United States
(12) Patent Application Publication
(10) Pub. No.: US 2013/0211945 A1
(43) Pub. Date: Aug. 15, 2013

(54) Method and System for Purchasing Property Options

(71) Applicant: George Basil Po-Ching, Waitakere City (NZ)

(72) Inventor: George Basil Po-Ching, Waitakere City (NZ)

(21) Appl. No.: 12/597,896

(22) PCT Filed: Apr. 24, 2008
(86) PCT No.: PCT/NZ08/00084

§ 371 Date: Jan. 22, 2010

(30) Foreign Application Priority Data
Apr. 27, 2007 (NZ) 554854

(51) Int. Cl. G06Q 50/16; G06Q 30/08

(52) U.S. Cl. CPC G06Q 50/16; G06Q 30/08
USPC 705/26.3

(57) ABSTRACT

The present invention relates to a method, system and or software for selling property comprising or adapted for: providing details of a property item for review 10, receiving one or more bids one from or more bidders 11, the bidders being entities wanting to purchase the property item, wherein each bid relates to a price the corresponding bidder is willing to pay for the property, providing the successful bidder with an option 13 to buy the property at the successful bid price.

### FIELD OF THE INVENTION

The field of the invention general relates to property auctions and in particular but not solely to online auctions for the purchase of property options for high value items such as real estate, vehicles and the like.

### DESCRIPTION OF RELATED ART

Online auctions typically result in the purchase of the item for sale by the highest bidder above or at the reserve price. However the purchase of real estate or other high value property items is a major transaction and many people are likely to be put off purchasing property items using an online auction.

For example, for the majority of people, purchasing a home is the biggest investment they will make and it is a cautious decision not taken lightly by committing hundreds of thousands of dollars using the click of a mouse. Auctions restrict potential bidders to only those whose finances are already in place because the successful bidder is committed to purchase. To bid at a property auction one normally has to be present or be represented, thus restricting the number of auctions one can be at any one time.

Traditional auctions for property also have other disadvantages. The cost of advertising the sale and the commissions involved result in high expenses for the seller. Travelling to an auction and having finances in place can result in a smaller group of buyers bidding. The internet has allowed sellers to advertise real estate properties for sale by auction but generally this is a weak and reckless process because neither party is legally bound by the transaction.

### SUMMARY OF THE INVENTION

It is an object of the present invention to provide a method of auctioning property items or at least provide the public or industry with a useful choice.

Here, the term “property” is used in its broad legal sense to mean any tangible or intangible item that is or can be owned. For clarity, the term “property item” is used to refer to a particular piece of property for sale, be that real estate, vehicle or any other type of ownable property.

In a first aspect the present invention may broadly be said to consist in a method for selling property comprising: providing details of a property item for review; receiving one or more bids one from or more bidders, the bidders being entities wanting to purchase the property item, wherein each bid relates to a price the corresponding bidder is willing to pay for the property, providing the successful bidder with an option to buy the property at the successful bid price.

Preferably the successful bidder is the entity that placed a successful bid, the successful bid being the best bid, or a bid that is accepted by an owner of the property item.

Preferably the successful bid price is the successful bid of the successful bidder.

Preferably the method further comprises receiving payment from the successful bidder prior to providing the option to buy the property.

Preferably the option to buy the property gives the successful bidder the exclusive right to buy the property at the successful bid price for a limited time period, after which the successful bidder no longer has the exclusive right to buy the property.

Preferably at least the provision of details of a property item for review and the reception of bids takes place on the internet.

Preferably the property item is one or more of:

real estate,

jewellery,

vehicle,

boat,

animal,

intellectual property,

financial instrument.

Preferably the successful bidder is not obligated to exercise the option to buy the property item.

Preferably the bid comprises one or more conditions.

Preferably the seller can negotiate the price and/or conditions of a bid prior to establishing a successful bid.

Preferably the bids form part of one or more of a/an:

auction,

tender,

negotiation,

private treaty.

In another aspect the present invention may broadly be said to consist in a method for selling property comprising: providing details of a property item for review, receiving one or more bids one from or more bidders, the bidders being entities wanting to win an option to purchase the property, providing the successful bidder with an option to buy the property at the successful bid price.

In another aspect the present invention may broadly be said to consist in a system for selling property, the system comprising a web server providing an online auction system that is adapted to: provide details of a property item for review, receive one or more bids one from or more bidders, the bidders being entities wanting to win an option to purchase the property item, determine the successful bidder, being the person entitled to receive an option to purchase the property item.

In another aspect the present invention may broadly be said to consist in a system for selling real estate, comprising a web server including an online auction system, said online auction system including:

a user registration system;

a listing interface for a seller to post a listing;

a bidding interface for a buyer to bid on a listing;

wherein said listing interface is for auctioning an option to purchase real estate, the successful option holder will have a period of time to confirm the purchase of real estate.

Preferably said option is binding upon the bidder/buyer and the seller/agent for a limited period.

Preferably said listing interface includes the ability for said seller to set a reserve price.

Preferably said listing interface includes the ability for said seller to set a purchase now price.

Preferably said bidding interface includes the ability for said buyer to add conditions to their bid.

Preferably said listing interface includes the ability for a seller to select the conditions the seller will allow in a buyers bid.

Preferably said bidding interface includes a checking unit to check that the conditions selected by the bidder are allowable by the seller before accepting a bid.

Preferably said listing lists the top conditional and unconditional bids.

Preferably said listing interface allows a seller to discount said bid price according to the conditions said buyer has added to their bid.

Preferably said online auction system includes a top bid calculating unit, said top bid calculating unit including a calculator for calculating the top bid.

Preferably, a computer program implementing the system above is provided.

In another aspect the present invention may broadly be said to consist in method of selling teal estate comprising offering for auction the option but not obligation to purchase a property.

In another aspect the present invention may broadly be said to consist in a method of selling real estate as defined above wherein said auction is conducted online.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular fauns of the noun.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### BRIEF DESCRIPTION OF THE DRAWINGS

Preferred embodiments of the invention will be described with reference to the following drawings, of which:

FIG. 1 is a flow diagram of a general method for carrying out an auction,

FIG. 2 is a block diagram showing a system that carries out the method,

FIGS. 3, 4 show the steps carried out by the sellers and buyers respectively,

FIG. 5 is a flow diagram of a method according to one embodiment of the invention,

FIG. 6a, 6b shows a screen shot of details defining a listing,

FIG. 7a, 7b shows a screen shot of a listing,

FIGS. 8a, 8b show a screen shot of a bid form,

FIG. 9 shows a screen shot of a confirmation of bid page,

FIG. 10 shows a confirmation of bid page,

FIGS. 11a, 11b show a counter offer page,

FIG. 12 shows a counter offer confirmation page,

FIG. 13 shows a further counter offer page,

FIG. 14 shows a bid acceptance page,

FIG. 15 shows a bid acceptance page,

FIG. 16 shows an option certificate.

### DESCRIPTION OF THE PREFERRED EMBODIMENTS

### Overview of the Invention

The present invention relates to a method, software and/or system for facilitating the sale of property items through an auctioning process. Preferably, the method, software and/or system is implemented by way of a web site hosted on a web server as is known in the art. It is envisaged that the web site would allow bidders/buyers and sellers to register as existing internet auction sites do. Alternatively the present invention could be incorporated into an existing online auction site.

The property item could be any ownable property such as (but not restricted to): real estate, jewellery, vehicles, boats, animals, intellectual property, financial instruments.

The present invention removes the inconvenience of having to travel to an auction or other bidding process by allowing the bidder to bid online from anywhere. The duration of this auction or other process may last from a few minutes to one or many days or even longer, allowing greater exposure to potential bidders and creating a fairer market price.

The method, software and/or system provides an auction or other bidding process for an option to buy a property item. The participants bid for purchase of the property. The bidding process comprises providing bids or offers for purchase of a property item. A bid comprises a price, and preferably (although not necessarily) one or more conditions in relation to any sale and purchase agreement that might ultimately eventuate. A bid can be placed in a suitable bidding process, such as an auction, tender, simple offer, negotiation, private treaty or any other suitable means. Any process might have one or a number of bidders, all placed according to the nature of the process. In one embodiment, as will be described in this specification, the bids are placed in an auction, but this should not be considered a limiting feature.

The winner of the auction (the successful bidder) is entitled to an option to buy the property item, this giving them the exclusive right to buy the property within a time period, although it does not obligate them to do so. Because the auction is for the option to purchase a property item, restrictions (such as having finances already in place) are removed. It also provides an opportunity for the option holder to do due diligence on the property item before committing to purchase.

It is envisaged that the option would last for 7 days, although any suitable time period could be used. The length of the option could be selected by the seller from a number of choices when the seller lists the option to purchase.

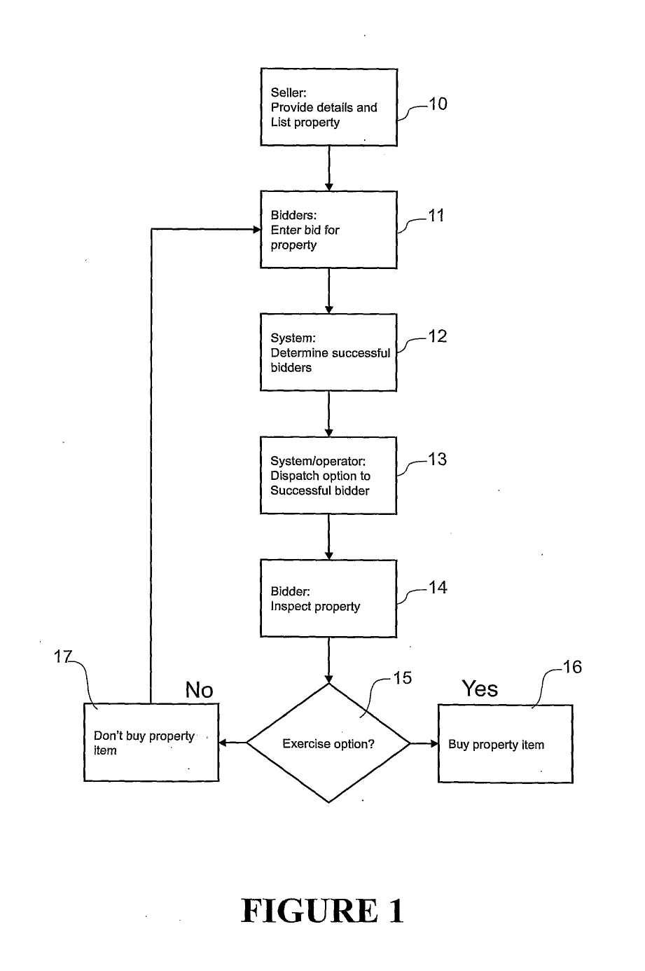

An overview of a method, system and software for implementing the invention according to one embodiment will be described with reference to FIGS. 1 to 4.

FIG. 1 shows an overview of the method. The seller will list a property item and provide details of that item, step 10. Entities or parties interested in purchasing the property item can then enter bids, step 11. Preferably, these bids will reflect the price the bidders wish to pay for the property item. The bid might optionally comprise conditions. However, the auction is not for purchase of the property item, but for an option to purchase the property item. A computer system/software then determines a successful bidder, step 12. The successful bidder can then receive the option to purchase the property, step 13. The successful bidder will typically be the party who entered the highest bid, or the bid that is accepted by the seller. The successful bidder who receives the option, can then do due diligence, step 14 and decide whether to exercise their option to purchase the property item, step 15. If they do exercise that right step 16, a normal sale and purchase process is undertaking. Where the bids reflect the price the bidders are willing to pay for the item, the option holder, if they wish to exercise that option, will be obligated to pay the successful bid price to the seller. At that point, the parties would enter into a normal sale and purchase agreement, at the successful bid price, along with any conditions that formed part of the bid. If they do not, the seller is not obligated to sell, and the option would lapse. Clearly, these terms could be re-negotiated, if the parties are mutually happy to do so. If the successful bidder decides not to exercise the option 17, then the auction process can optionally recommence.

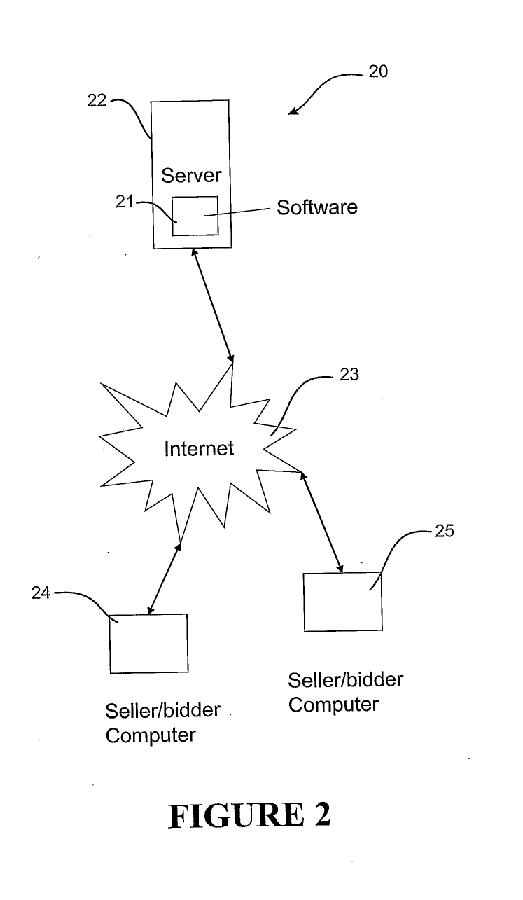

The method could be implemented in software on a computer system. FIG. 2 shows a system 20 that could execute software 21 that implements the invention. The system 20 comprises a server 22 connected to a network, such as the internet 23. The server 22 executes software 21 that provides listings of property items for sale, and an auction interface. This can be accessed by sellers and bidders over the internet, using computer terminals 24, 25. Bids can be entered, and software executing on the server can process the bids, determine winners and update graphical user interfaces for viewing by end users to keep them informed of progress. The server 22 could also administrate part or all of the option payment and dispatch processes, or this could be done by another mechanism, such as manually.

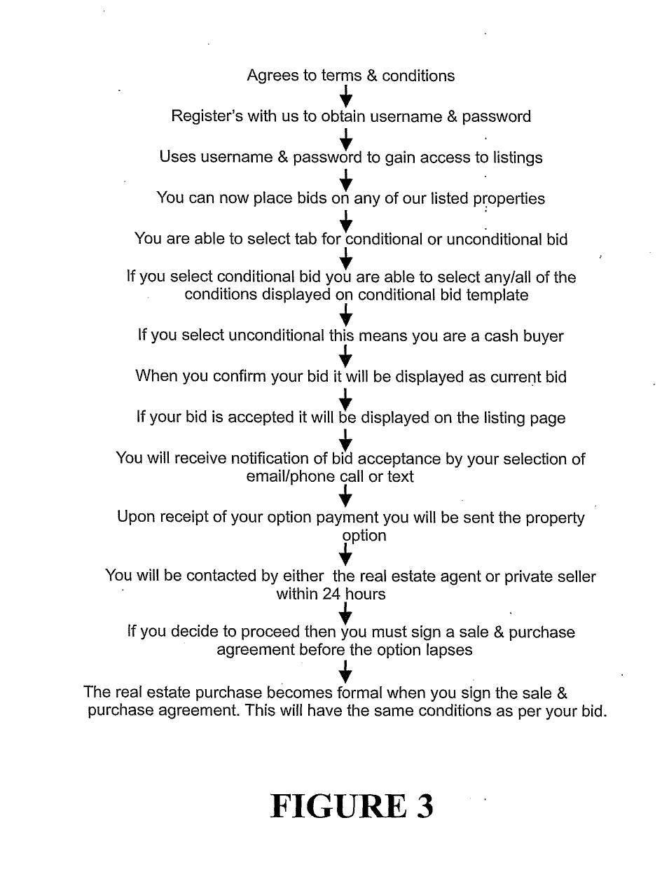

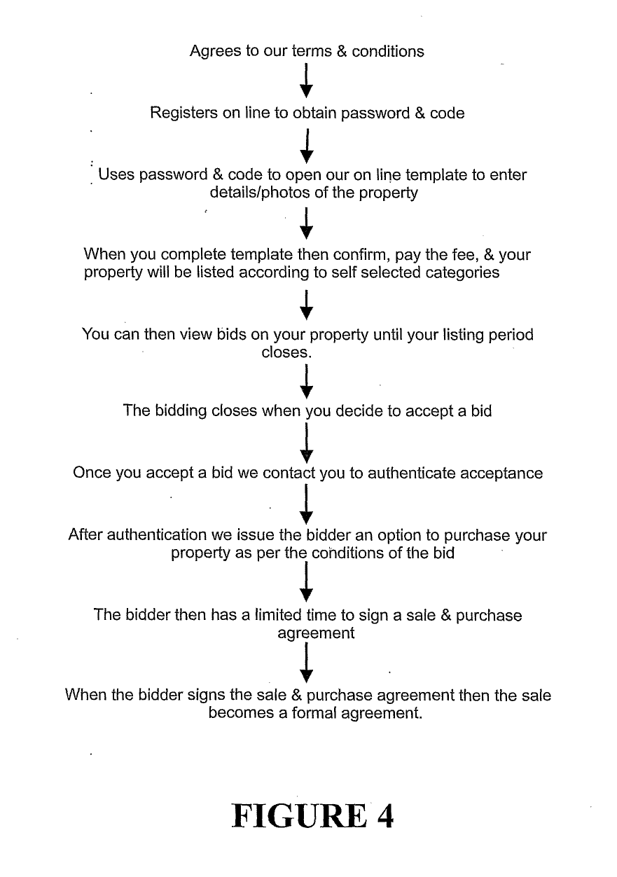

The seller and bidder processes are described briefly with reference to FIGS. 3 and 4.

The process a seller goes through is illustrated in FIG. 3. The seller would list their property item. In this embodiment, the property item is real estate, but this is used by way of example only. The seller would provide details such as the number of bedrooms, the property's legal description and any other relevant information.

The listing template afforded to the seller would include a conditional tab and an unconditional tab.

The seller would then add any conditions they wanted placed on the purchase and any conditions that the seller would allow a buyer to add. Such conditions may include but are not limited to: a period of time for the buyer to sell their property item; a period of time for the buyer to obtain legal advice; and/or a period of time for a buyer to obtain finance. The seller would also set the starting bid and the reserve for the auction. Any conditions offered to prospective bidders would likely be predetermined and consist of the most common conditions. It is envisaged that the options would be limited in number so as to avoid confusion or detract from convenience.

The auction is selling the right but not the obligation to purchase the property. It is envisaged that the buyer would have 7 days to examine the property item or other due diligence and to sign a binding agreement. If the buyer has no other conditions attached to their offer then the binding agreement needs to be signed by the end of the 7 days otherwise the option may lapse. If there are other conditions the agreement signed within the 7 days may include those conditions or again the option may lapse.

It is envisaged that successful bidders would have to pay an option fee after the auction is completed confirming their interest and secure the option. Failure to pay the option fee might result in the next highest bidder being offered the purchase option. Alternatively potential buyers may have to pay a fee before bidding. Such a fee would discourage reckless bidders wasting the seller's time.

Another option could be that a bidder places a bid in the auction, and the seller then proceeds to accept the bid. Upon the seller's acceptance of the bid, the bidder would become the successful bidder. They would then have a short time (such as 24 hours) to pay an option fee (such as $500). If the payment of the option fee is not received within this period, the bid is then removed and the successful bidder does not receive the option. If the successful bidder does pay the option fee, they become the potential buyer. Both the potential buyer and seller will receive a “Property Option Certificate”. The potential buyer will now have 7 days to complete a Sale & Purchase Agreement. Failure to complete the Sale & Purchase Agreement within this time voids the option. The property is then placed back on the market and the buyer is optionally entitled to a fee refund, although this may be subject to an administration. fee (for example, less 10% for administration costs).

The process that a buyer goes through is illustrated in FIG. 4. A bidder may also impose conditions on their bid, such as subject to finance or solicitor's approval. It is envisaged that the system would rank bids according to the conditions a bidder has added to their bid. Therefore, a bid that has no conditions might be rated higher than a bid with multiple conditions. The system may also show the current highest conditional and unconditional bids. It is further envisaged that a seller could devalue bids depending on the conditions the buyer has selected. So for example a seller might value a bid subject to finance at $5000 less than a bid not subject to finance. The values that a seller places on conditions could be entered on the listing page.

Using the values a seller places on conditions would allow the system to identify the top bids.

In a further alternative the seller could list a purchase now price. In a further alternative the seller could receive from the buyer a payment for the option.

During the option period it is envisaged that the buyer can exercise the option. In order that the option is binding upon the seller the seller may have to sign an agreement prior to the auction going live. Another alternative would be for the seller to sign a contract with the system manager agreeing to be bound.

It is envisaged that both the seller and the buyer would pay a fee to the system manager. Alternatively only one party may pay a fee.

It must be emphasised that the auction is for the sale of property options whereas traditional auctions are for the sale of real estate. Although one may think this a subtle change in practical terms there is a vast difference because now the buyer and seller are bound by the conditions of the property option for a period of time.

The credibility of this process is that the seller has committed to a price and the successful bidder has paid for an option. The option has a time lapse allowing the buyer to bid with confidence knowing that there is time for further enquiries and if the real estate does not measure up to expectations then the buyer can let the option lapse without penalty.

While property auctions and option to purchase are known what is unique is that an auction held specifically for the purchase of a property option. This is an improved and useful procurement procedure for the purchase of property. The final objective of the option being the sale and purchase of real estate.

It is intended that the property option be a legal and binding document with time constraints arid the facility to include conditions. By definition property options are intended to relate to any document/agreement that have a time limit and whereby the expiration of the time limit leaves neither party with any liability to the other party.

### First Embodiment

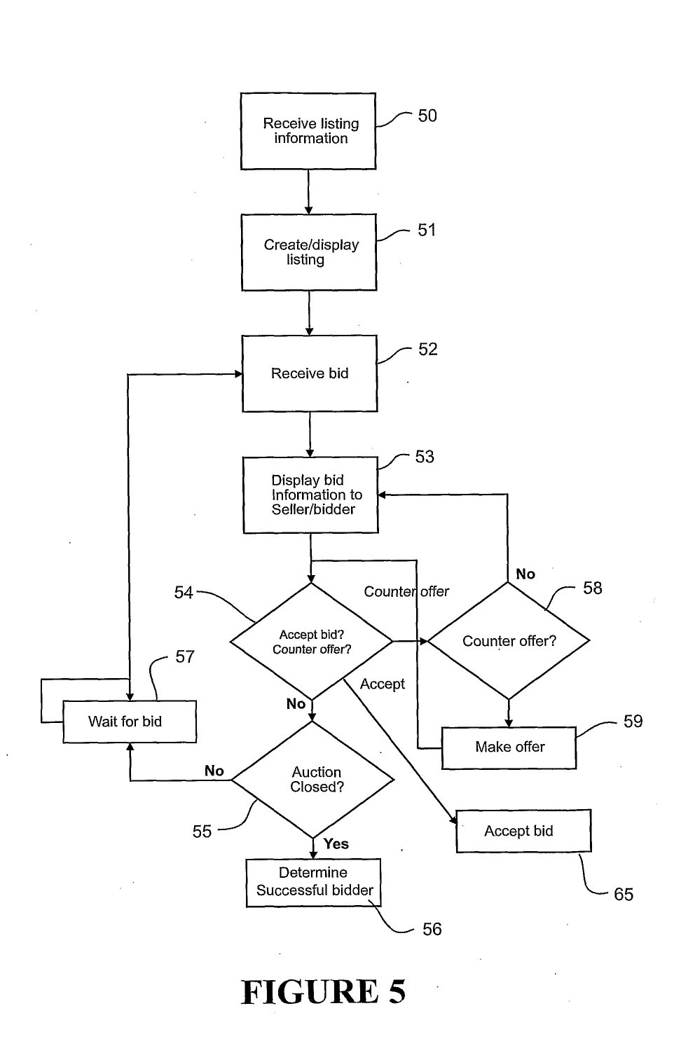

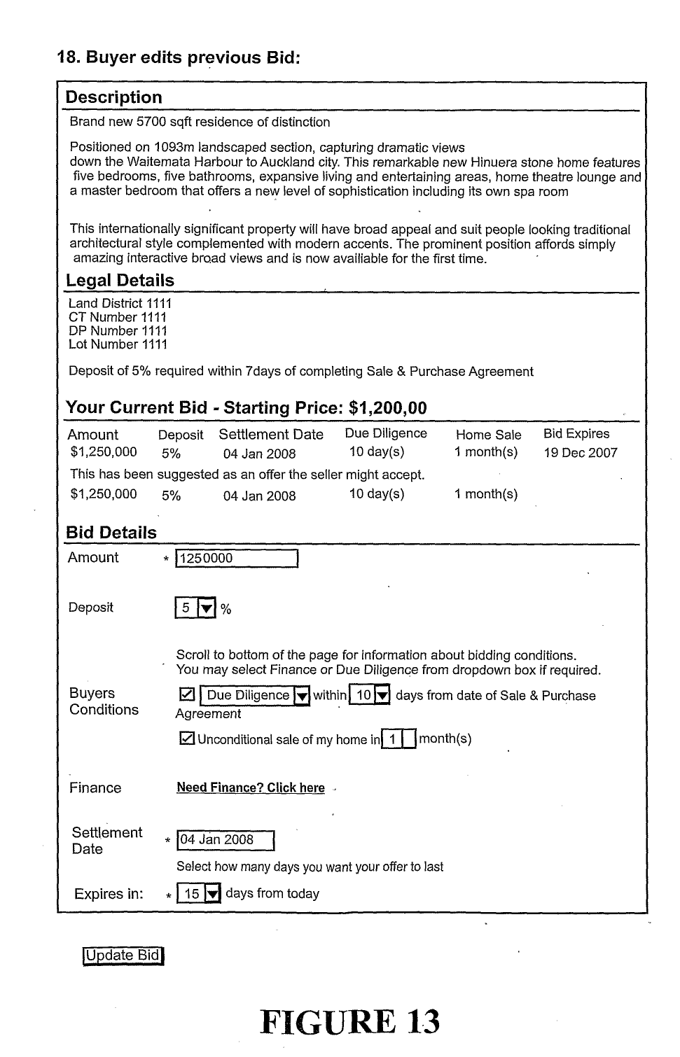

A preferred embodiment of the invention will be described with reference to FIGS. 5-16. This shows how the method might be implemented from a seller's and bidder's perspective by way of a graphical user interface, and the process undertaken by the system using software.

FIG. 5 shows a method carried out by a system 22 executing software 21 implementing the method. Typically the method will be implemented on a server 21 that will receive information on listings and bids from users via the internet 23, do the necessary processing, and then display results and information on bids via the internet 23 to the end user computers 24, 25.

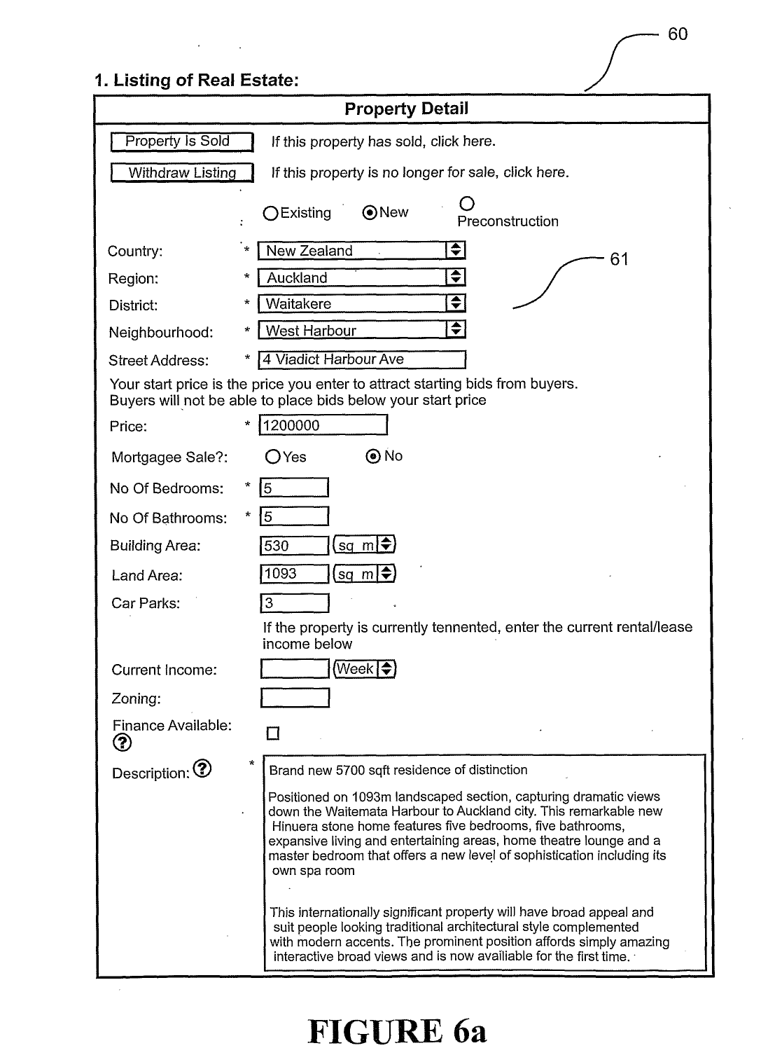

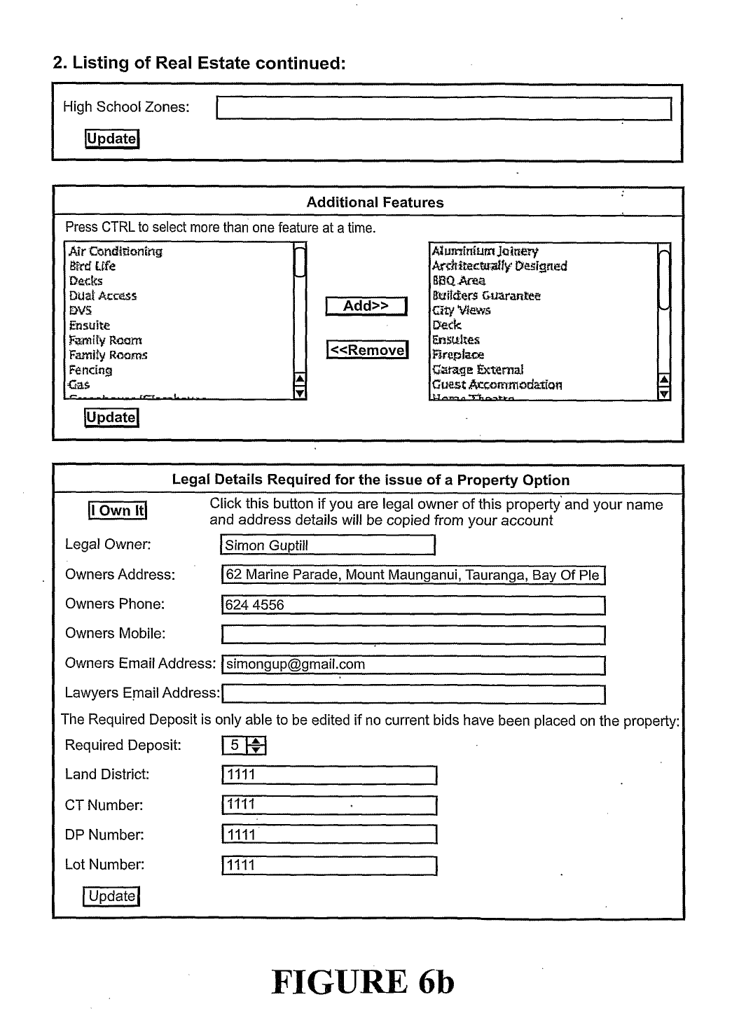

First, the method comprises receiving information from a seller detailing the property item they wish to sell, step 50. This enables the server to create a listing. Referring to FIGS. 6a and 6b preferably, the information is received via a form 60 that is provided from the server 22 to the seller's computer 25 over the internet 23. The form 60 allows the user to input various information 61 regarding the property item for sale, which in this case is the house. Among the information 61 that can be entered is the property location, description on the number of bedrooms, land size, minimum bid, a general description, additional features, and also the legal description. Other information could also optionally be provided, such as photographs, information on open home times and anything else that is suitable.

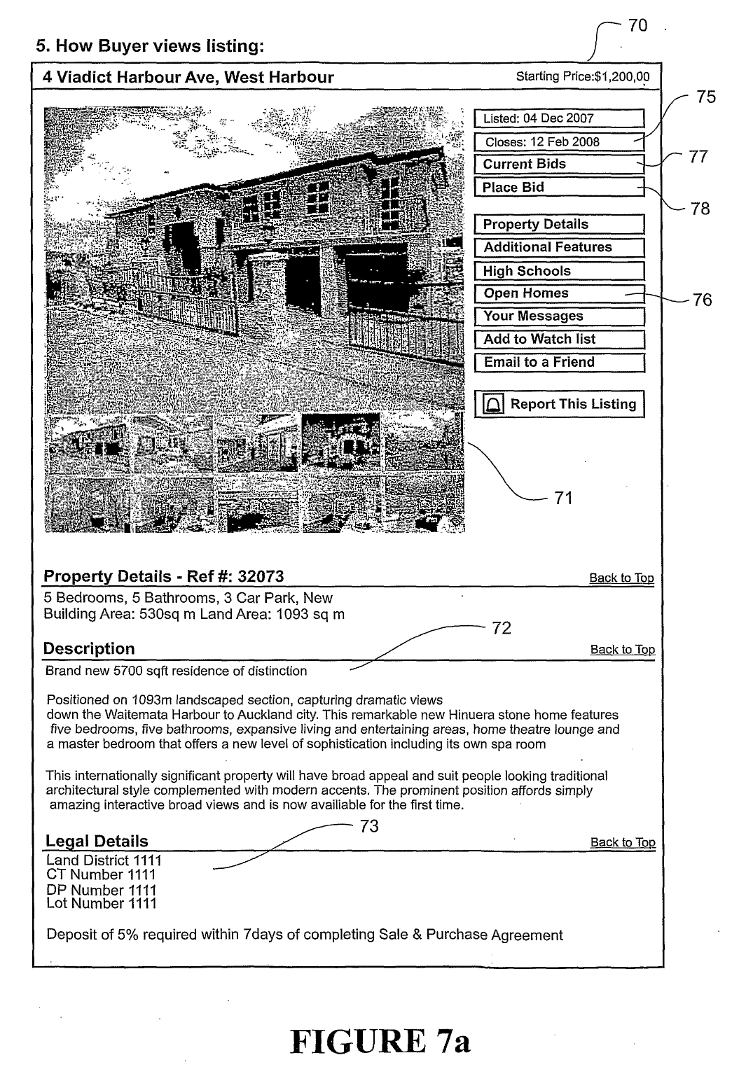

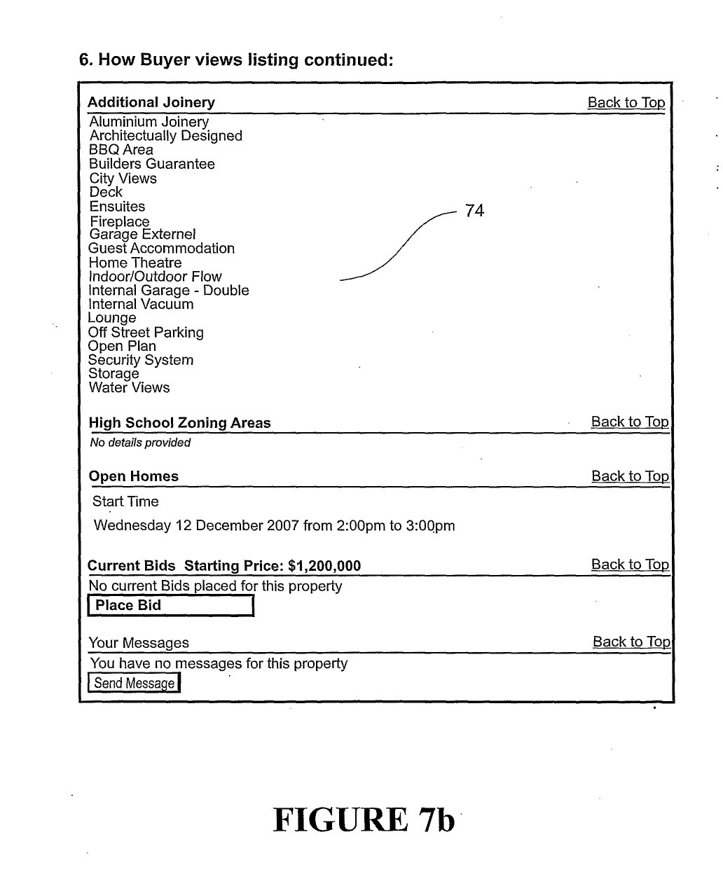

Upon submitting the form the server 22 receives the information and creates a listing in their database, step 51. They optionally email the seller confirming that the listing has successfully been made. Next, the server generates a display for the listing, that can be accessed via a web browser over the internet 23 by end user 24, 25, step 51. A potential buyer can browse a summary of listings, and choose those of interest to review the further details. An example of a web page that may be displayed to a potential buyer over the Internet display further details is shown in FIG. 7a, 7b.

The property listing 70 contains various information, including photos of the property 71, general 72 and legal descriptions 73 and any other useful information 74. It also indicates when the auction closes 75 (if it is an auction), and allows viewing of further information 76. It also enables someone viewing the information to view current bids 77, by clicking on the appropriate icon, or to place a bid 78.

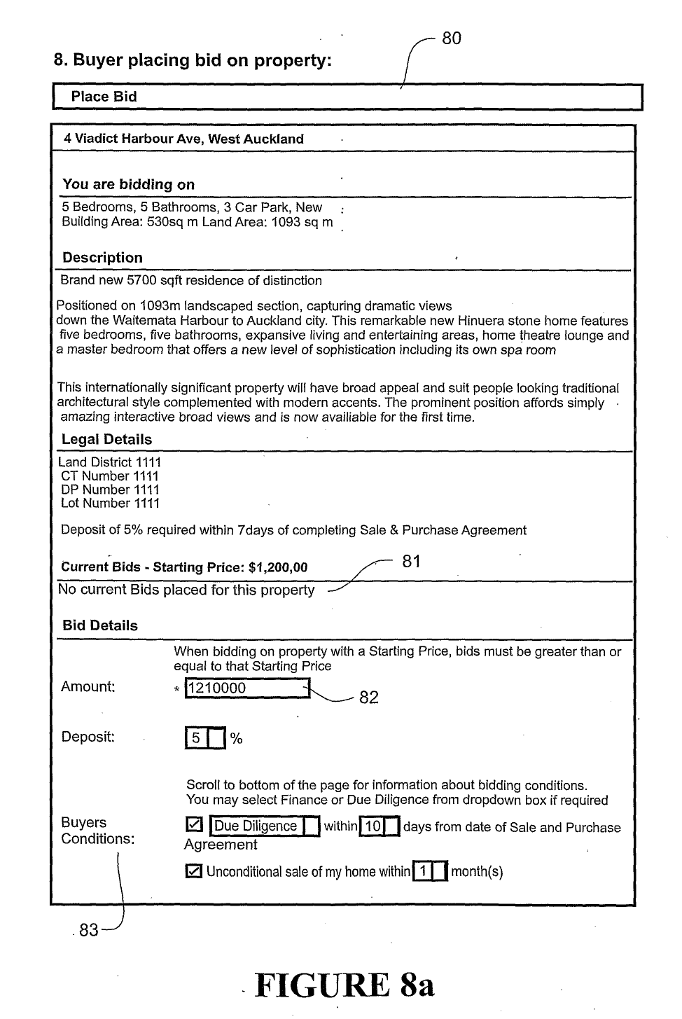

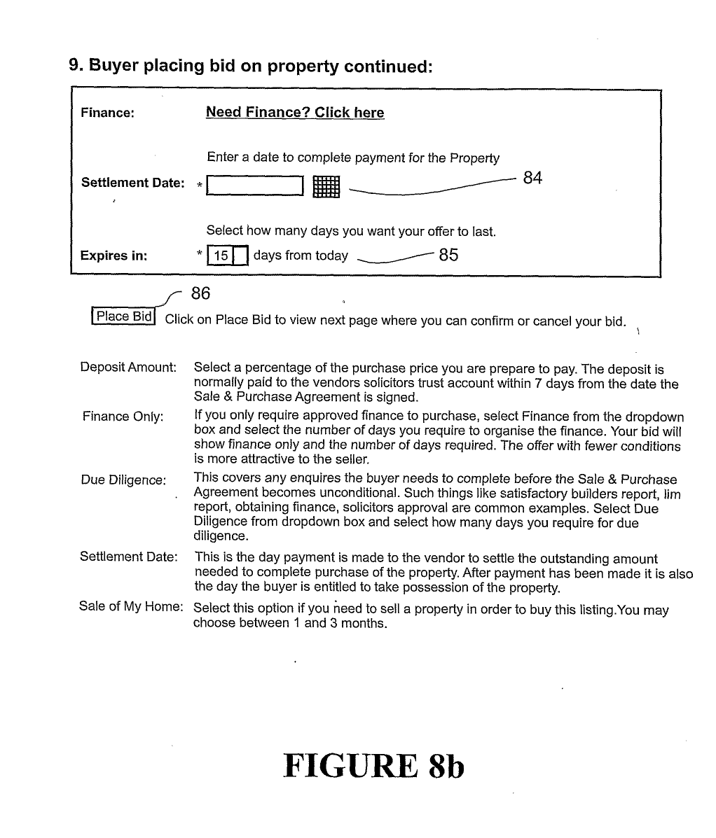

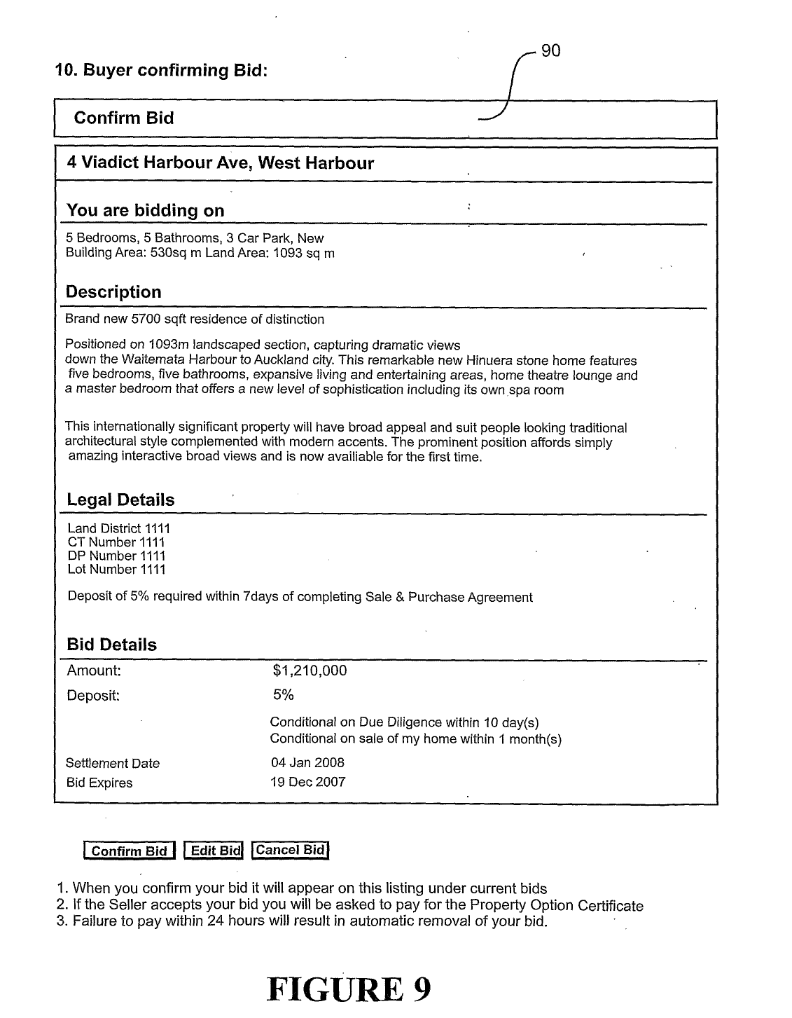

The server 22 can then receive bids from parties interested in purchasing the property item, step 52. The server 22 provides the web pages to the end user required for entering a bid. If a user decides to place a bid, they click on the place bid icon 78, and then are taken to a bidding page 80 (see FIGS. 8a, 8b) that is generated and provided by the server 22. The bidding form 80 comprises all the necessary information on the property item being offered for sale, along with current bids 81. The bidder can enter theft desired bid in the bid field 82, in this case $1,210,000. In a preferred embodiment, this will be the price they are willing to pay for purchase of the property item, should they win the bidding process (which actually results in them winning an option to buy the property at the successful bid price). The bidder can also enter any conditions they may wish to put on the sale and purchase agreement should they actually sign one upon exercising their option to buy and a deposit percentage. A settlement date 84 can be entered, also along with an offer expiry date 85. Upon clicking the place bid button 86, the server 22 generates a confirmation page 90 (FIG. 9) displaying all the relevant details to the user. The user can then confirm 91, edit 92 or cancel 93 their bid using the appropriate buttons. Upon confirming the bid, the bid is received by the server, step 52 and stored for processing. The bid is recorded as the highest bid, and the current bid in the database is updated to reflect this. Anyone now reviewing the listing will see the latest placed bid, being $1,210,000.

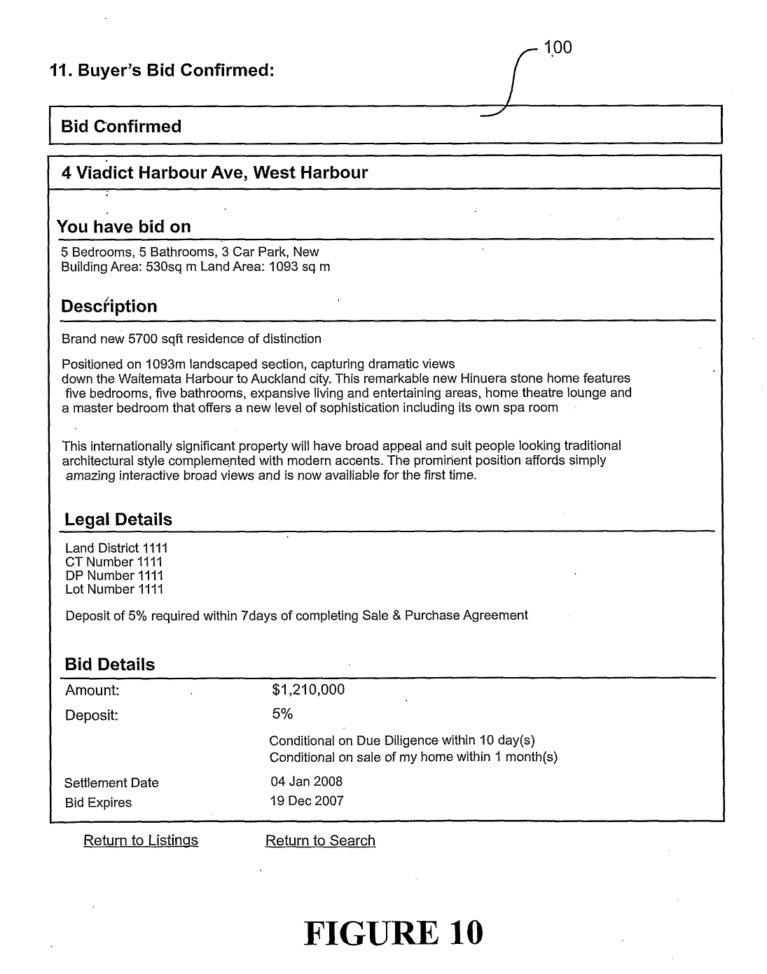

The server 22 then confirms (to the seller and bidder) that a bid has been received, step 53. This is done by sending an email to the seller and/or bidder with the bid information. Additionally, or alternatively, it comprises displaying a bid confirmation page online 100 (see FIG. 10).

Bids could simply be placed in this fashion, according to the bidding process (e.g. auction, open/closed tender or the like). The best bid would then be the successful bid, the bidder having the right to the option to purchase. The best bid could be based on any suitable criteria, such as highest bid at end of tender/auction, most favourable conditions (according to any suitable metric), or what is most favourable to the seller based on theft own subjective criteria. The best bid could be determined based on the specified criteria either by the computer, the seller or some combination of them both. In a preferred embodiment, the seller (or system) does not just have to assess the bids as they are. They have the further opportunity to negotiate changes to one or more bids with the respective bidders, resulting in more desirable bids. These altered bids can then be assessed in the most appropriate way to determine the successful bidder. In the case of a traditional auction/tender bidding process being used, the seller might not have the opportunity to counteroffer or accept bids. They might be obliged to accept the highest bid (above a reserve) according to normal rules.

However, in the preferred embodiment, negotiation on a bid is permitted For example, after one or more bids are placed, the seller has the option to (in respect of each bid) accept the bid, step 54, counter offer, or simply ignore the bid at this stage and let the bidding process run its normal course until completion. Assuming the seller does not accept the bid, if the bidding process has not yet closed, step 55, the server then goes into a waiting pattern for receiving further bids, step 57. If another bid is received step 52 then the same process is undertaken (steps 52 to 55, 57) and the server displays, step 53, the bid to the seller and bidder, and updates the current bid for viewing by third parties. This bid can also be accepted, counter offered or ignored. This process carries on until the bidding is over, step 55, 56 or a bid is accepted, steps 54 to 59, 65.

As noted, the seller can override the bidding process by accepting a bid before the process closes, step 54. The seller may accept the bid outright, or make a counter offer, step 58. If the bid is accepted, step 65, the bidding process stops and the bidder placing the accepted bid is considered the successful bidder and is entitled to the option to purchase the property item.

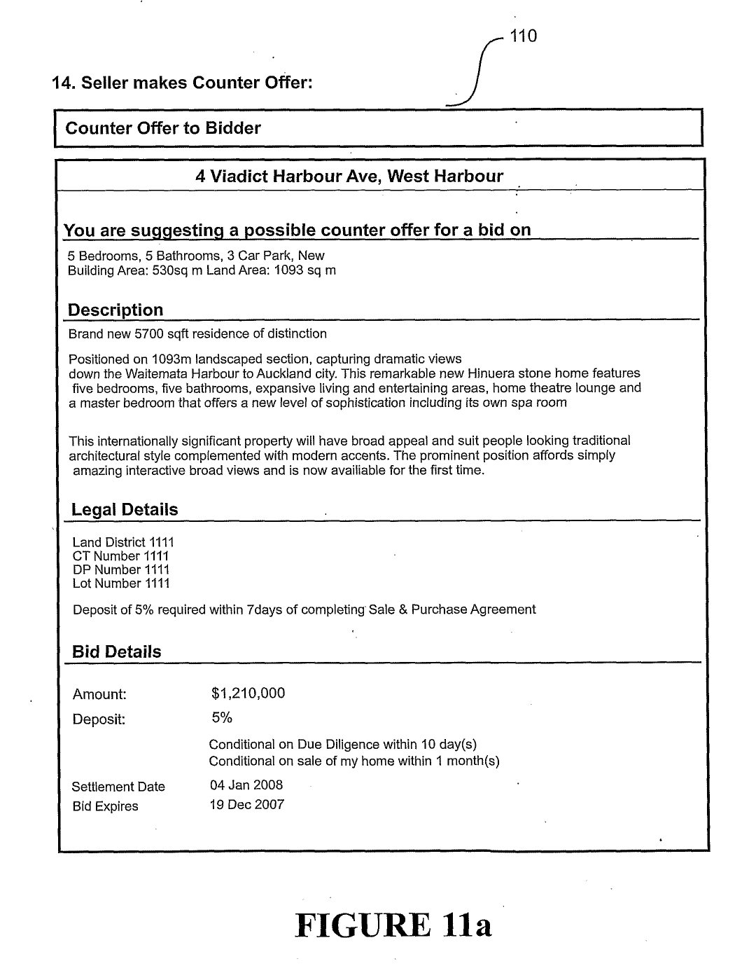

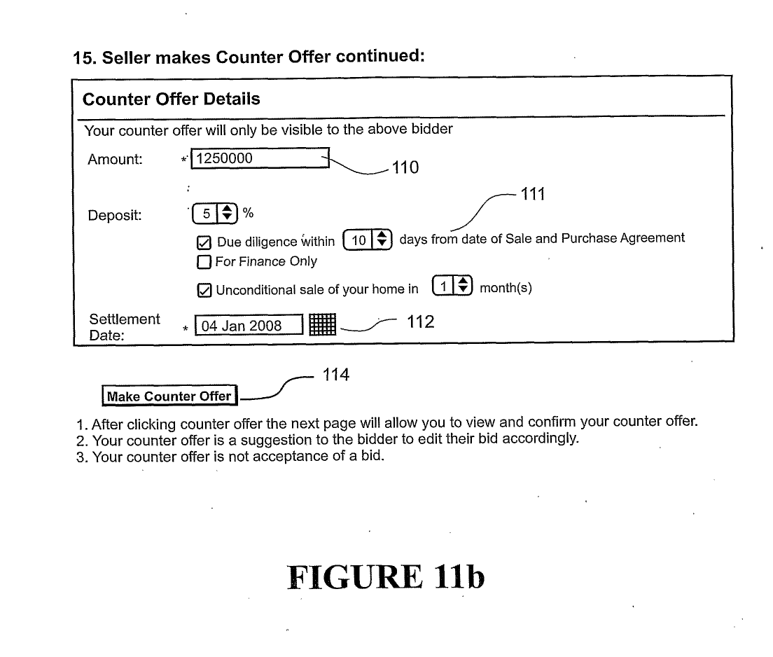

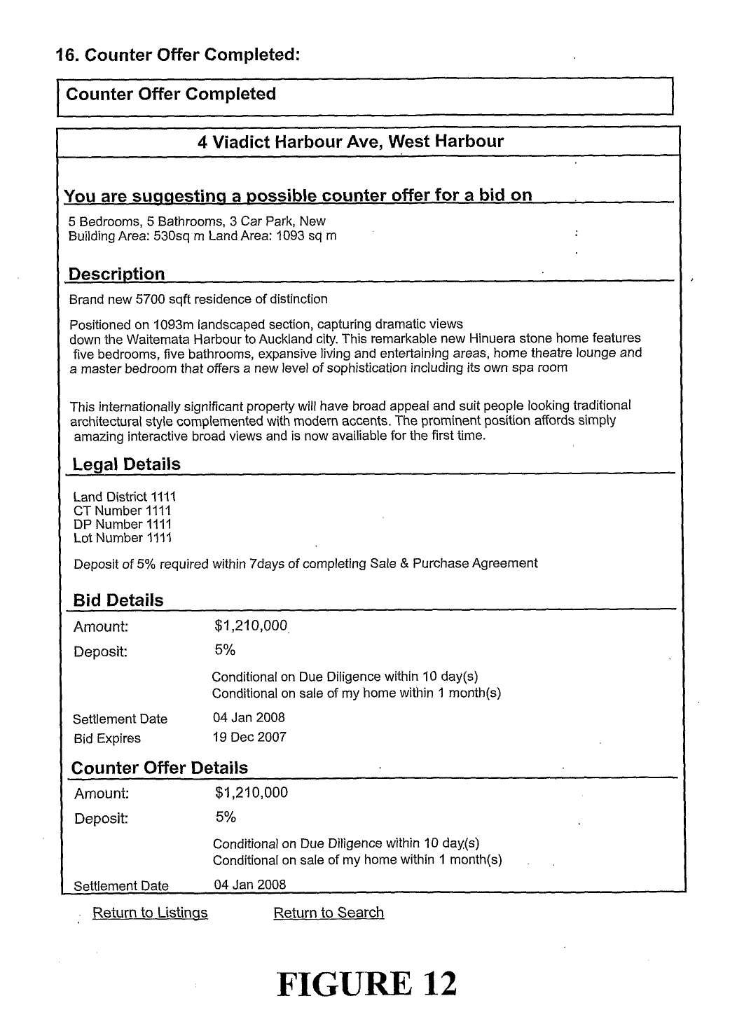

Alternatively, the seller can make a counter offer, step 59. This is done by completing a form provided by the server 22. The counter offer form 110 is shown in FIGS. 11a, 11b. The property item details are shown along with the bid. Further, a field is provided by the server allowing the seller to enter an amount for a counter bid, in this case $1,250,000. The conditions 112 and the settlement date 113 can also be amended, if desired. After clicking the counter offer button 114, the counter offer is confirmed and the page 120 (see FIG. 12) is displayed indicating the details of the counter offer. The counter offer is emailed to both the buyer and the seller. The buyer may make their own counter offer as shown in FIGS. 10a and 10b in the same manner, step 58, 59. This is confirmed in the same manner, by email and/or display of a web page. This process continues until the seller or the bidder accepts a counter offer and therefore accepts the bid, step 65. If an offer is not agreed on, the bid will simply go back into the current bid of the main bidding process. If the bid is accepted, step 65 the main bidding process ceases and the accepted bid becomes the successful bid. A seller might negotiate simultaneously on several bids, trying in each case to obtain favourable price and conditions. When they achieve that on any particular bid through the counter offer process, the seller can accept that bid, resulting in a successful bidder/bid.

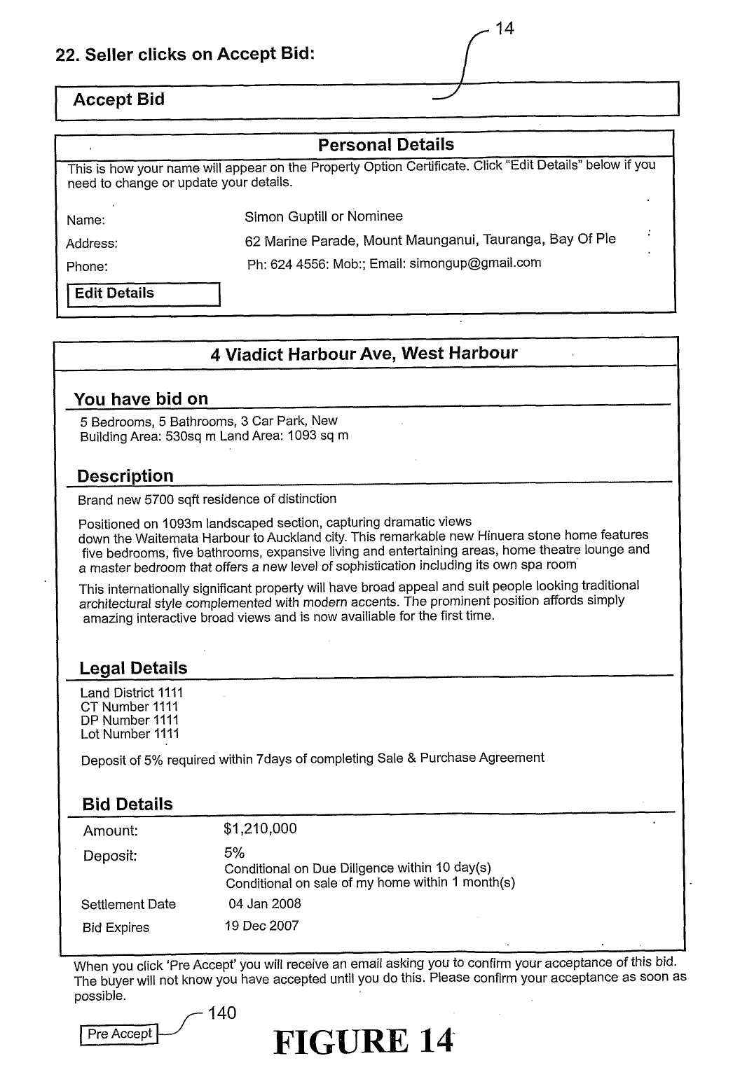

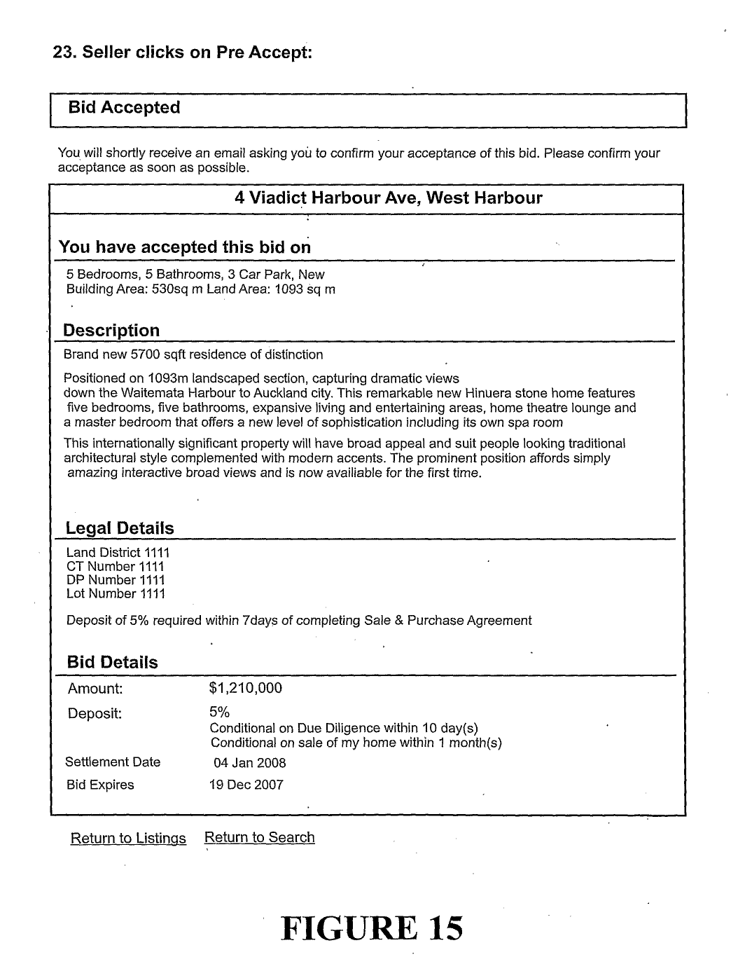

A bid can be accepted on the page as shown in FIG. 14, by clicking the accept button 140. Confirmation of that acceptance will be emailed, and/or displayed as shown in FIG. 15. For safety, a two stage bid acceptance process may take place where the entity first does a pre-acceptance, then makes full acceptance in writing at a later time.

If a bid is not accepted by the seller (or no agreement is reached regarding counter offers), the process continues until the bidding process ceases, step 55. This might be after a time limit, for example. :At that point the server determines if there is a successful bid, and who that successful bidder is, step 56. If the current bid is higher than the reserve price, then the successful bidder is the person who placed that bid. In this case they will be entitled to receive an option to purchase the property item, as described above.

At this point the server may arrange to receive payment and dispatch the property purchase option to the successful bidder, step 66. Alternatively, this may be done by manual process. Similarly, if the bidding process/successful bidder is resolved by way of the seller/buyer accepting a bid/counter offer, step 65, again the server will determine that that bidder is the successful bidder and entitle them to receive a property option. Again, the server 22 may arrange to receive payment and dispatch of the property option, step 66, or this may be done manually.

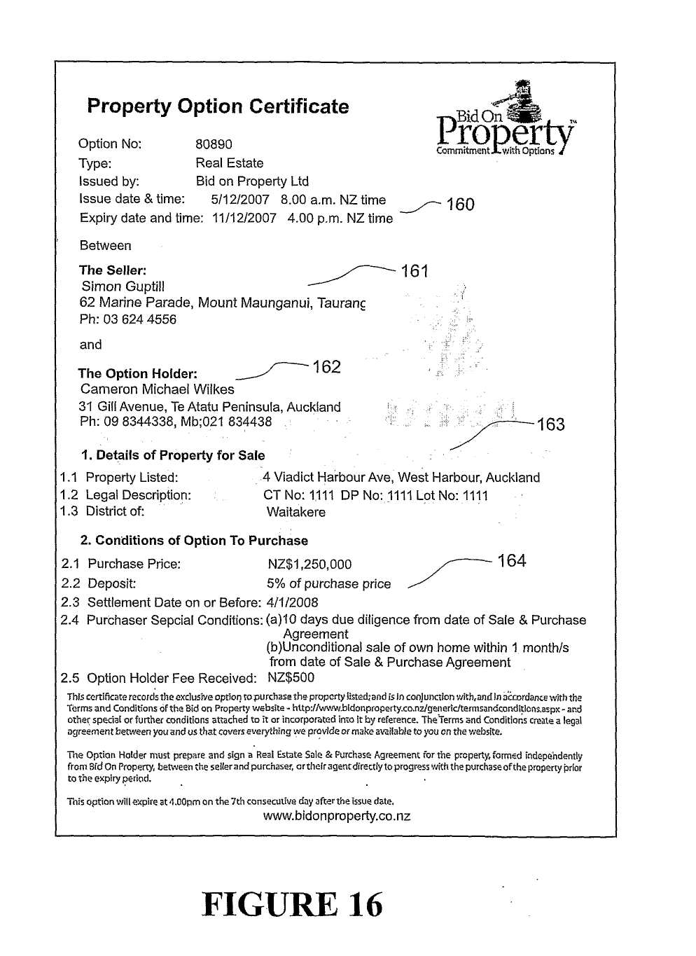

FIG. 16 shows an option certificate that is provided to the successful bidder upon receipt of the option payment. It sets out the property type 160 and description 163, the seller 161, the option holder 162 and the details agreed to for purchase of the property including the price and conditions 163, 164. This document gives the successful bidder the right to purchase the property, but under no obligation to do so, for the purchase price and under any conditions negotiated during the bidding process. If they do not wish to purchase the property by the due date, then the option lapses. The seller has no obligation to accept demand of sale for a price less than the purchase price agreed upon in the auction. Further, the seller has no obligation to enter a sale and purchase agreement on terms other than those forming part of the successful bid.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

1. A method for selling property comprising:
providing details of a property item for review,
receiving one or more bids one from or more bidders, the bidders being entities wanting to purchase the property item, wherein each bid relates to a price the corresponding bidder is willing to pay for the property,
providing the successful bidder with an option to buy the property at the successful bid price.

2. A method according to claim 1 wherein the successful bidder is the entity that placed a successful bid, the successful bid being the best bid, or a bid that is accepted by an owner of the property item.

3. A method according to claim 1 wherein the successful bid price is the successful bid of the successful bidder.

4. A method according to claim 1 further comprising receiving payment from the successful bidder prior to providing the option to buy the property.

5. A method according to claim 1 wherein the option to buy the property gives the successful bidder the exclusive right to buy the property at the successful bid price for a limited time period, after which the successful bidder no longer has the exclusive right to buy the property.

6. A method according to claim 1 wherein at least the provision of details of a property item for review and the reception of bids takes place on the internet.

7. A method according to claim 1 wherein the property item is one or more of:
real estate,
jewellery,
vehicle,
boat,
animal,
intellectual property,
financial instrument.

8. A method according to claim 1 wherein the successful bidder is not obligated to exercise the option to buy the property item.

9. A method according to claim 1 wherein the bid comprises one or more conditions.

10. A method according to claim 1 wherein the seller can negotiate the price and/or conditions of a bid prior to establishing a successful bid.

11. A method according to claim 1 wherein the bids form part of one or more of a/an:
auction,
tender,
negotiation,
private treaty

12. A method for selling property comprising:
providing details of a property item for review
receiving one or more bids one from or more bidders, the bidders being entities wanting to win an option to purchase the property,
providing the successful bidder with an option to buy the property at the successful bid price.

13. A system for selling property, the system comprising a web server providing an online auction system that is adapted to:
provide details of a property item for review
receive one or more bids one from or more bidders, the bidders being entities wanting to win an option to purchase the property item,
determine the successful bidder, being the person entitled to receive an option to purchase the property item.

14. A system for selling real estate, comprising a web server including an online auction system, said online auction system including:
a user registration system;
a listing interface for a seller to post a listing;
a bidding interface for a buyer to bid on a listing;
wherein said listing interface is for auctioning an option to purchase real estate, the successful option holder will have a period of time to confirm the purchase of real estate.

15. A system for selling real estate as claimed in claim 14 wherein the option is binding upon the bidder/buyer and the seller/agent for a limited period.

16. A system for selling real estate as claimed in claim 14 wherein said listing interface includes the ability for said seller to set a reserve price.

17. A system for selling real estate as claimed in claim 14 wherein said listing interface includes the ability for said seller to set a purchase now price.

18. A system for selling real estate as claimed in claim 14 wherein said bidding interface includes the ability for said buyer to add conditions to their bid.

19. A system for selling real estate as claimed in claim 14 wherein said listing interface includes the ability for a seller to select the conditions the seller will allow in a buyers bid.

20. A system for selling real estate as claimed in claim 14 wherein said bidding interface includes a checking unit to check that the conditions selected by the bidder are allowable by the seller before accepting a bid.

21. A system for selling real estate as claimed in claim 14 wherein said listing lists the top conditional and unconditional bids.

22. A system for selling real estate as claimed in claim 14 wherein said listing interface allows a seller to discount said bid price according to the conditions said buyer has added to their bid.

23. A system for selling real estate as claimed in claim 14 wherein said online auction system includes a top bid calculating unit, said top bid calculating unit including a calculator for calculating the top bid.

24. A computer program implementing the system of claim 14.

25. A method of selling real estate comprising offering for auction the option but not obligation to purchase a property.

26. A method of selling real estate as claimed in claim 25 wherein said auction is conducted online.
